(19) United States
(12) Patent Application Publication
(10) Pub. No.: US 2026/0093378 A1
(43) Pub. Date: Apr. 2, 2026

(54) LOW-LATENCY, SELECTIVE, AFFIRMATIVE, AND/OR REVERSIBLE ACKNOWLEDGEMENT OF MESSAGE TRANSMISSION

(71) Applicant: The Sunnai Marali Company Inc., Sacramento, CA (US)

(72) Inventors: Naia Suhyoon Hahn, Honolulu, HI (US); Geoffrey Sungjun Hahn, Honolulu, HI (US); Eric Kyungmo Hahn, Honolulu, HI (US)

(21) Appl. No.: 19/347,528

(22) Filed: Oct. 1, 2025

Related U.S. Application Data
(60) Provisional application No. 63/702,019, filed on Oct. 1, 2024.

(51) Int. Cl. G06F 3/0482; H04L 51/23

(52) U.S. Cl. CPC G06F 3/0482; H04L 51/23

(57) ABSTRACT

A message recipient may receive a text message from a message sender in a chat room between the message sender and a message recipient on a mobile application executing on a smartphone associated with the message recipient. The mobile application may detect a short press input from the message recipient with respect to the message indicating that a read receipt associated with the message is to be transmitted to the message sender. The mobile application may detect a long press input from the message recipient with respect to the message indicating the recipient desires to take further action with respect to the text message for which the read receipt has been displayed. The mobile application may detect a second short press from the message recipient with respect to the message indicating that the read receipt associated with the message is to be removed.

### CROSS-REFERENCE TO RELATED APPLICATIONS

The present application claims the benefit of U.S. Provisional Application No. 63/702,019, filed Oct. 1, 2024, which is hereby incorporated by reference in its entirety.

### BACKGROUND

### Field

The present disclosure generally relates to systems, methods, and devices for acknowledgement of message transmission.

### SUMMARY

Various embodiments described herein relate to systems, methods, and devices for message transmission. The present disclosure generally relates to a method of low-latency, selective, affirmative, and/or reversible acknowledgement of a message.

In particular, in some embodiments, described herein is a method for allowing a message recipient to selectively, affirmatively, and/or reversibly acknowledge receipt of a message in a low-latency or low-delay manner and further allowing the message recipient to take other actions (e.g., like, delete, edit, send a message of affirmative acknowledgement, etc.) with a long press. The method comprises receiving a text message from a message sender in a chat room between the message sender and a message recipient on a mobile application executing on a smartphone associated with the message recipient; detecting a short press user input from the message recipient with respect to the text message, indicating that a read receipt associated with the text message is to be transmitted to the message sender; transmitting the read receipt to the message sender such that an indication that the text message has been received and acknowledged by the message recipient is displayed both on the message sender's display screen and the message recipient's display screen; subsequent to displaying the indication on both of the display screens, detecting a second short press user input from the message recipient with respect to the text message, indicating that the message recipient desires to take further action with respect to the text message for which the read receipt has been displayed; in response to detecting the second short press user input, causing the indication that the message has been received and acknowledged by the message recipient to be removed from both the message sender's display screen and the message recipient's display screen; detecting a long press user input from the message recipient with respect to the text message, indicating that the message recipient desires to take further action with respect to the text message for which the read receipt has been displayed; and in response to detecting the long press user input, causing a user interface element including multiple available user actions to be displayed on the message recipient's display screen for selection by the message recipient.

In other embodiments, described herein is a system for selectively, affirmatively, and/or reversibly acknowledging receipt of a message in a low-latency or low-delay manner. The system comprises a sender device associated with a message sender; a recipient device associated with a message recipient, configured at least to: receive a text message from a message sender in a chat room between the message sender and a message recipient on a mobile application executing on a smartphone associated with the message recipient; detect a first short press user input from the message recipient with respect to the text message, indicating that a read receipt associated with the text message is to be transmitted to the message sender; transmit the read receipt to the message sender such that an indication that the text message has been received and acknowledged by the message recipient is displayed both on the message sender's display screen and the message recipient's display screen; subsequent to displaying the indication on both of the display screens, detect a second short press user input from the message recipient with respect to the text message, indicating that the message recipient desires to take further action with respect to the text message for which the read receipt has been displayed; in response to detecting the second short press user input, cause the indication that the message has been received and acknowledged by the message recipient to be removed from both the message sender's display screen and the message recipient's display screen; detect a long press user input from the message recipient with respect to the text message, indicating that the message recipient desires to take further action with respect to the text message for which the read receipt has been displayed; and in response to detecting the long press user input, cause a user interface element including multiple available user actions to be displayed on the message recipient's display screen for selection by the message recipient.

In other embodiments, described herein is a non-transitory computer-readable medium storing instructions that, when executed by a processor, cause a computer system to perform a method for acknowledging message transmission comprising: receiving a text message from a message sender in a chat room between the message sender and a message recipient on a mobile application executing on a smartphone associated with the message recipient; detecting a short press user input from the message recipient with respect to the text message, indicating that a read receipt associated with the text message is to be transmitted to the message sender; transmitting the read receipt to the message sender such that an indication that the text message has been received and acknowledged by the message recipient is displayed both on the message sender's display screen and the message recipient's display screen; subsequent to displaying the indication on both of the display screens, detecting a second short press user input from the message recipient with respect to the text message, indicating that the message recipient desires to take further action with respect to the text message for which the read receipt has been displayed; in response to detecting the second short press user input, causing the indication that the message has been received and acknowledged by the message recipient to be removed from both the message sender's display screen and the message recipient's display screen; detecting a long press user input from the message recipient with respect to the text message, indicating that the message recipient desires to take further action with respect to the text message for which the read receipt has been displayed; and in response to detecting the long press user input, causing a user interface element including multiple available user actions to be displayed on the message recipient's display screen for selection by the message recipient.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 illustrates a flow diagram according to one or more embodiments of methods of acknowledging message transmission of the present disclosure.

FIG. 2 illustrates a flow diagram according to one or more embodiments of methods of acknowledging message transmission of the present disclosure.

FIG. 3 illustrates a computer system according to one or more embodiments of systems for acknowledging message transmission of the present disclosure.

### DETAILED DESCRIPTION

The detailed description set forth below in connection with the drawings is intended as a description of various configurations and is not intended to represent the only configurations in which the concepts described herein may be practiced. The detailed description include specific details for the purpose of providing a thorough understanding of various concepts. However, it will be apparent to those skilled in the art that these concepts may be practiced without these specific details.

All patents, applications, published applications and other publications referred to herein are incorporated herein by reference to the referenced material and in their entireties. If a term or phrase is used herein in a way that is contrary to or otherwise inconsistent with a definition set forth in the patents, applications, published applications and other publications that are herein incorporated by reference, the use herein prevails over the definition that is incorporated herein by reference.

All technical and scientific terms used herein have the same meaning as commonly understood to one of ordinary skill in the art to which this disclosure belongs unless clearly indicated otherwise.

As used herein, the singular forms “a”, “and”, and “the” include plural referents unless the context clearly dictates otherwise. Thus, for example, reference to “a sequence” may include a plurality of such sequences, and so forth.

The terms comprising, including, containing and various forms of these terms are synonymous with each other and are meant to be equally broad. Moreover, unless explicitly stated to the contrary, examples comprising, including, or having an element or a plurality of elements having a particular property may include additional elements, whether or not the additional elements have that property.

As used herein, the term “read receipt” refers to an indication that a text message had been received and acknowledged by the message recipient. In particular, in some embodiments, “read receipt” may refer to a symbol (e.g., one checkmark, two checkmarks, etc.), text (e.g., “Read”, “Read at 12:30pm”, etc.), or other visual indicator (e.g., removing an unread indicator, change in color, design effect, etc.) on the display screen of the message sender and/or the message recipient. In particular, in some embodiments, “read receipt” may appear underneath or somewhere adjacent to the corresponding text message on the display screen of the message sender and/or the message recipient.

### Introduction

Aspects of the present disclosure relate generally to communication systems, devices, and methods. In particular, in some embodiments, the present disclosure relates to communication systems, devices, and methods for low-latency, selective, affirmative, and/or reversible acknowledgement of message transmission.

Some text messaging apps provide read receipts, indicating to the sender that the recipient has read the sent messages. They are often automatically sent such that as soon as the recipient opens the chat with the sender, a read receipt is provided to the sender (e.g., adding “Read at 11:45am” next to the message, adding a check mark next to the message, or removing an unread indicator from the message). However, such read receipts only indicate that the messages were displayed on the recipient's screen, and do not actually indicate whether the recipient has read and understood the sent messages. In reality, to let the sender know that the messages were received and understood, the recipient may need to, in addition to the read receipts, send a reply message such as “Got it” or “Thanks” to let the sender know that the recipient received and understood the sent messages, or “like” the messages or add a “thumbs up” to the messages, which are cumbersome and time-consuming. To address these deficiencies, according to this disclosure, a message recipient perform a one-touch or two-touch action (e.g., short press, tap, double tap, swipe, etc.) to send manual, affirmative read receipt that is less cumbersome to send than a text message or a reaction (e.g., like, heart, thumbs up, etc.). For example, the recipient can simply perform a short press on a received message, and a read receipt can be transmitted to the sender, indicating that the recipient received and understood the message.

Upon receiving a message, recipients generally open the chat with the sender to assess the urgency and often may not be able to immediately reply. Since read receipts are generally sent as soon as the recipient opens the chat, read receipts may give the sender a false impression that the recipient has actually read and understood the message (e.g., “read at 12:45pm” regardless of whether the recipient has read the corresponding message or not). This may be especially of concern where a recipient is receiving multiple text messages within a short time period and/or from multiple senders.

To address these challenges, it may be desirable to provide message recipients with the options of selectively, affirmatively, and/or reversibly acknowledging any given message received by the recipient. Selective acknowledgment allows both the recipient and the sender to keep track of which messages the recipient has read and/or addressed. Affirmative acknowledgement allows both the recipient and the sender to know that the recipient has actively and intentionally acknowledged the receipt of the message. Reversible acknowledgment, including an option to remove a read receipt, similarly helps both recipients and senders avoid confusion, mistake, and/or miscommunication over which messages have and have not been addressed by the recipient. According to this disclosure, in some embodiments, reversible acknowledgement of message transmission may include but is not limited to removing the read receipt from both the display screen of a mobile device associated with the recipient and the display screen of a mobile device associated with the sender.

One or more features described herein may be implemented in any combination. Also, any single feature or combination of features may be used instead of automatic acknowledgement or in addition to automatic acknowledgement.

### SUMMARY

In some embodiments, described herein is a method for allowing a message recipient to selectively, affirmatively, and/or reversibly acknowledge receipt of a message in a low-latency or low-delay manner and further allowing the message recipient to take other actions (e.g., like delete, edit, etc.) with a long press. The method comprises receiving a text message from a sender in a chat room on a mobile application executing on a smartphone associated with the message recipient; detecting a short press user input from the message recipient with respect to the text message, indicating that a read receipt associated with the text message it to be transmitted to the message sender; transmitting the read receipt to the message sender such that an indication that the text message has been received and acknowledged by the message recipient is displayed both on the message sender's display screen and the message recipient's display screen; subsequent to displaying the indication on both of the display screens, detecting a long press user input from the message recipient with respect to the text message, indicating that the message recipient desires to take further action with respect to the text message for which the read receipt has been displayed; and in response to detecting the long press user input, causing a user interface element including multiple available user actions to be displayed on the message recipient's display screen for selection by the message recipient.

In other embodiments, described herein is a method for allowing a message recipient to selectively, affirmatively, and/or reversibly acknowledge receipt of a message in a low-latency or low-delay manner and further allowing the message recipient to reverse the acknowledgement of receipt of a message with a second short press. The method comprises receiving a text message from a sender in a chat room on a mobile application executing on a smartphone associated with the message recipient; detecting a short press user input from the message recipient with respect to the text message, indicating that a read receipt associated with the text message it to be transmitted to the message sender; transmitting the read receipt to the message sender such that an indication that the text message has been received and acknowledged by the message recipient is displayed both on the message sender's display screen and the message recipient's display screen; subsequent to displaying the indication on both of the display screens, detecting a second short press input from the message recipient with respect to the text message, indicating that the message recipient desires to take further action with respect to the text message for which the read receipt has been displayed; and in response to detecting the second short press user input, causing the indication that the message has been received and acknowledged by the message recipient to be removed from both the message sender's display screen and the message recipient's display screen.

In yet other embodiments, described herein is a system for selectively, affirmatively, and/or reversibly acknowledging receipt of a message in a low-latency or low-delay manner. The system comprises a sender device associated with a message sender; a recipient device associated with a message recipient, configured at least to: receive a text message from a sender in a chat room on a mobile application executing on a smartphone associated with the message recipient; detect a short press user input from the message recipient with respect to the text message, indicating that a read receipt associated with the text message it to be transmitted to the message sender; transmit the read receipt to the message sender such that an indication that the text message has been received and acknowledged by the message recipient is displayed both on the message sender's display screen and the message recipient's display screen; subsequent to displaying the indication on both of the display screens, detect a long press user input from the message recipient with respect to the text message, indicating that the message recipient desires to take further action with respect to the text message for which the read receipt has been displayed; and in response to detecting the long press user input, cause a user interface element including multiple available user actions to be displayed on the message recipient's display screen for selection by the message recipient.

In other embodiments, described herein is a system for selectively, affirmatively, and/or reversibly acknowledging receipt of a message in a low-latency or low-delay manner and further allowing the message recipient to reverse the acknowledgement of receipt of a message with a second short press. The system comprises a sender device associated with a message sender; a recipient device associated with a message recipient, configured at least to: receive a text message from a sender in a chat room on a mobile application executing on a smartphone associated with the message recipient; detect a short press user input from the message recipient with respect to the text message, indicating that a read receipt associated with the text message it to be transmitted to the message sender; transmit the read receipt to the message sender such that an indication that the text message has been received and acknowledged by the message recipient is displayed both on the message sender's display screen and the message recipient's display screen; subsequent to displaying the indication on both of the display screens, detect a second short press input from the message recipient with respect to the text message, indicating that the message recipient desires to take further action with respect to the text message for which the read receipt has been displayed; and in response to detecting the second short press user input, cause the indication that the message has been received and acknowledged by the message recipient to be removed from both the message sender's display screen and the message recipient's display screen.

### Low-latency, Selective, Affirmative, And/or Reversible Acknowledgment of Message Transmission

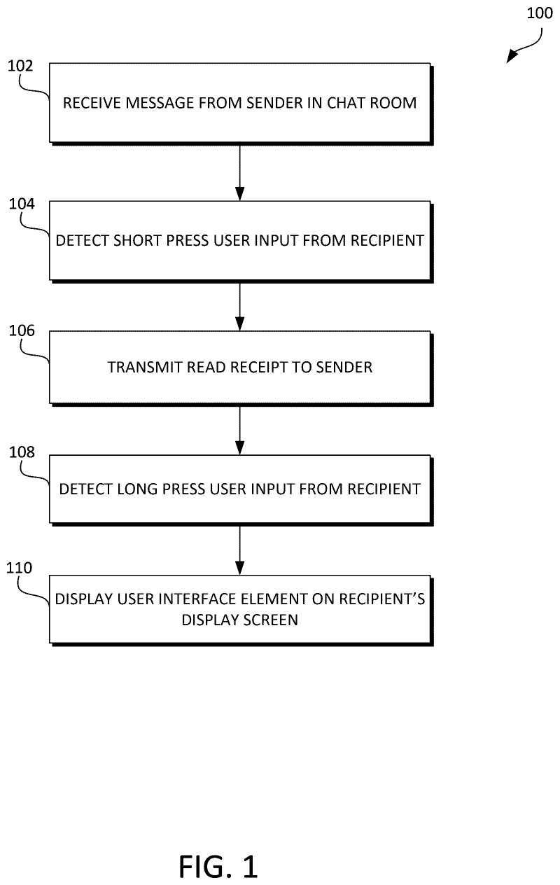

FIG. 1 depicts a flow diagram of a method 100 for allowing a message recipient to selectively, affirmatively, and/or reversibly acknowledge receipt of a message in a low-latency or low-delay manner and further allowing the message recipient to take other actions (e.g., like, delete, edit, send a message of acknowledgment, any combination thereof, etc.) with a long press. The method 100 starts at step 102 when a message recipient receives a text message from a sender in a chat room on a mobile application on the message recipient's smartphone. For example, a user may receive a notification that her friend has texted and subsequently open her text messaging app on her smartphone and select her friend's name from the list of chats. The message may be displayed on the display screen of her smartphone and also be displayed on the display screen of her friend's smartphone.

At step 104, the mobile application detects a short press user input with respect to the text message, indicating that a read receipt associated with the text message is to be transmitted to the message sender. The short press user input may include but may not be limited to a one-touch or two-touch action on the display screen (e.g., a touch for a predefined time period, tap, double-tap, swipe, any combination thereof, etc.). For example, depending on the desire of the message recipient, the message recipient may perform a short press or touch on the message to acknowledge receipt of the message and/or perform a long press, a swipe on the message (e.g., swipe left, right, up, or down), a double tap and/or any combination thereof to perform any other actions with respect to the message (e.g., like, delete, edit, send a message of acknowledgment, any combination thereof, etc.). In some embodiments, a long press user input on the message may send a read receipt and a different user input (e.g., a shorter hold, a tap, double-tap, swipe, etc.) may open a menu of options allowing the user to perform any other actions with respect to the message. In yet other embodiments, a long press user input may send a read receipt and a longer press or hold opens the menu of options. In yet other embodiments, each touch input is evaluated on a binary basis such that a touch shorter than a threshold duration is processed as a short touch/press/tap configured to initiate message acknowledgement and a touch longer than the threshold duration is processed as a long touch/press/tap configured to perform an alternative action (e.g., present a menu of potential actions that the user can perform on the corresponding message, such as like, thumbs up, heart, delete, edit, etc.). Step 104 detects the short press user input accordingly when the message recipient performs the short press on the message.

One technical advantage of this step is that the message recipient can indicate her affirmative acknowledgement of receipt of the text message in a less cumbersome way than sending another text message or a reaction (e.g., like, heart, thumbs up, etc.) in a selective, affirmative, reversible, and/or a low-latency or low-delay manner. Another technical advantage of this step is that the message recipient can manually, selectively indicate her affirmative acknowledgement of certain message, instead of automatically indicating that the message was displayed on the recipient's screen. Another technical advantage of this step is that indicating the desire of sending the read receipt does not affect, or is not affected by, the message recipient performing other actions to the message. In some embodiments, the message recipient may manually acknowledge message she has received from the message sender, instead of the most recent message, especially if the most recent message has not been fully processed by the recipient or if the recipient has not had a chance to read the most recent message.

In certain embodiments, detecting the short press user input further comprises delaying the transmission of the read receipt for a delay period (e.g., 3 seconds, 5 seconds, etc.), and during the delay period, displaying an option on the message recipient's display screen to allow the message recipient to undo the transmission of the read receipt. In response to a user input selecting the option to undo the transmission of the read receipt, preventing the indication from being displayed both on the message sender's display screen and the message recipient's display screen. The advantage in delaying the transmission of the read receipt and providing the recipient the option to undo the transmission of the read receipt is that the recipient can reverse an accidental acknowledgement of the message. The action to undo the transmission may be identical to the action to initiate the transmission (e.g., short touch). In other embodiments, the action to undo the transmission is different from the action to initiate the transmission (e.g., short touch may be used to initiate, a swipe may be used to undo).

At step 106, upon receiving the message recipient's desire to transmit the read receipt to the message sender, the mobile application transmits the read receipt to the message sender so that an indication that the text message has been received and acknowledged by the message recipient is displayed both on the message sender's display screen and the message recipient's display screen. For example, after the message recipient indicates her desire to transmit her read receipt associated with the message by performing a short tap or short touch on the message, the read receipt associated with the text message is transmitted to the message sender. The read receipt may be transmitted over cellular data, Wi-Fi, and/or any other wireless communication protocols. Upon receiving the read receipt by the message sender, the indication is displayed both on the message sender's display screen and the message recipient's display screen. In some embodiments, the indication may include, but may not be limited to, a short statement of acknowledgement associated with the message, such as a word of “read,” added next to the message. In some embodiments, the indication may include, but may not be limited to, a check mark next to the text message. In some embodiments, the indication may include, but may not be limited to, removing an unread indicator from the text message. In the above embodiments, the indication next to the message may be shown to the left, to the right, above, or below the message. In some embodiments, the message recipient may short tap on any message she has received from the message sender. In some embodiments, the indication may include a timestamp associated with a time at which the acknowledgment was received from the message recipient. In some embodiments, the indication may include a timestamp associated with a time at which the user input requesting to remove a previous acknowledgment was received from the message recipient.

In some embodiments, an automatic read receipt may be transmitted to the sender upon a message being successfully displayed on the recipient's screen (e.g., causing “displayed” to appear next to the message on the screen of the sender and/or the recipient), and an affirmative/selective read receipt may be transmitted to the sender upon the recipient performing the designated action with respect to the message (e.g., causing “displayed” to be replaced with “acknowledged” on the screen of the sender and/or the recipient, or causing another icon or indication to appear next to the message on the screen of the sender and/or the recipient).

At step 108, after displaying the affirmative/selective read receipt on both of the display screens, the mobile application detects a long press user input from the message recipient with respect to the text message, indicating that the message recipient desires to take further action with respect to the text message for which the read receipt has been displayed. For example, after displaying the read receipt on both of the display screens, the message recipient may further perform a short press or touch on the message to acknowledge receipt of another message and/or perform a long press, a swipe on the message (e.g., swipe left, right, up, or down), a double tap and/or any combination thereof to perform any other actions with respect to the message (e.g., like, delete, edit, etc.). In the example of FIG. 1, a long press user input is detected at step 108 when the message recipient performs the long press on the message. A user interface element may then be displayed on the message recipient's screen at step 110. One technical advantage of this step is that it allows alternative actions to be performed with respect to the message, while still reducing the latency associated with transmitting the selective/affirmative/reversible acknowledgement, which can lead to reduced screen time and/or increased battery life.

At step 110, in response to detecting the long press user input, the mobile application displays a user interface element including multiple available user actions on the message recipient's display screen for selection by the message recipient. For example, the multiple available user actions may include but may not be limited to like, heart, thumbs up, edit, delete, send a message of acknowledgement, any combination thereof, etc. In some embodiments, a long press user input on the message may send a read receipt and a different user input (e.g., a shorter hold, a tap, double-tap, swipe, etc.) may open a menu of options allowing the user to perform any other actions with respect to the message. In yet other embodiments, a long press user input may send a read receipt and a longer press or hold opens the menu of options. In some embodiments, the recipient can choose to send a message of affirmative acknowledgement from a menu of preselected options. In certain embodiments, the recipient can choose to prevent all further transmission of read receipts to the sender or prevent transmission of read receipts to the sender until a certain condition (e.g., time, location, etc.) is met.

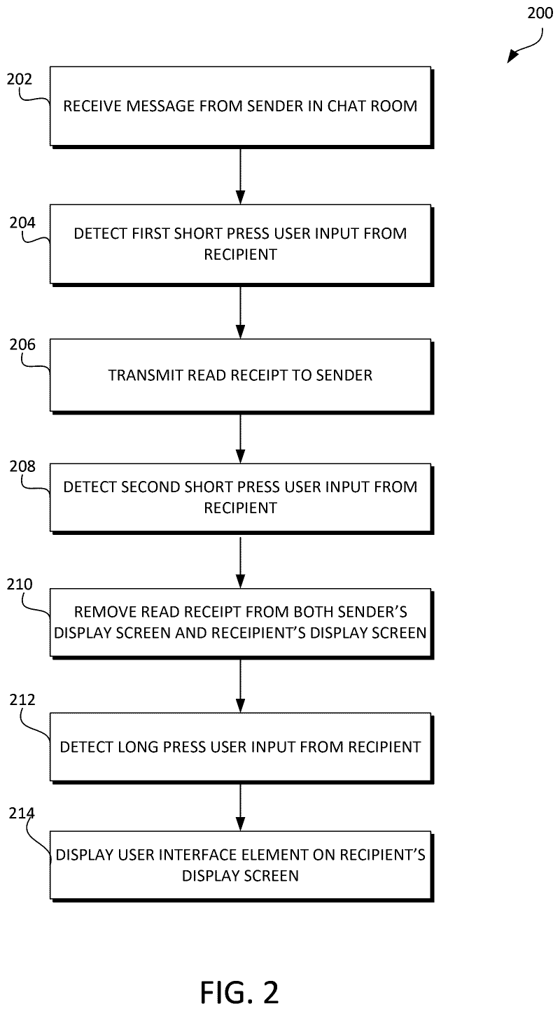

FIG. 2 depicts a flow diagram of a method 200 for allowing a message recipient to selectively, affirmatively, and/or reversibly acknowledge receipt of a message in a low-latency or low-delay manner and further allowing the message recipient to remove the acknowledgement with a second short press or tap. The method 200 starts at step 202 when a message recipient receives a text message from a sender in a chat room on a mobile application on the message recipient's smartphone. For example, a user may receive a notification that her friend has texted and subsequently open her text messaging app on her smartphone and select her friend's name from the list of chats. The message may be displayed on the display screen of her smartphone and also be displayed on the display screen of her friend's smartphone.

At step 204, the mobile application detects a short press user input with respect to the text message, indicating that a read receipt associated with the text message is to be transmitted to the message sender. The short press user input may include but may not be limited to a one-touch or two-touch action on the display screen (e.g., a touch for a predefined time period, tap, double-tap, swipe, any combination thereof, etc.). For example, depending on the desire of the message recipient, the message recipient may perform a short press or touch on the message to acknowledge receipt of the message and/or perform a long press, a swipe on the message (e.g., swipe left, right, up, or down), a double tap and/or any combination thereof to perform any other actions with respect to the message (e.g., like, delete, edit, send a message of acknowledgement, any combination thereof, etc.). In some embodiments, a long press user input on the message may send a read receipt and a different user input (e.g., a shorter hold, a tap, double-tap, swipe, etc.) may open a menu of options allowing the user to perform any other actions with respect to the message. In yet other embodiments, a long press user input may send a read receipt and a longer press or hold opens the menu of options. Step 204 detects the short press user input accordingly when the message recipient performs the short press on the message. One technical advantage of this step is that the message recipient can indicate her affirmative acknowledgement of receipt of the text message in a less cumbersome way than sending another text message or a reaction (e.g., like, heart, thumbs up, etc.) in a selective, affirmative, reversible, and/or a low-latency or low-delay manner. Another technical advantage of this step is that the message recipient can manually, selectively indicate her affirmative acknowledgement of certain message, instead of automatically indicating that the message was displayed on the recipient's screen. Another technical advantage of this step is that indicating the desire of sending the read receipt does not affect, or is not affected by, the message recipient performing other actions to the message. In some embodiments, the message recipient may short tap on any message she has received from the message sender, instead of the most recent message, especially if the most recent message has not been fully processed by the recipient or if the recipient has not had a chance to read the most recent message. In certain embodiments, detecting the short press user input further comprises scheduling transmission of the read receipt after a predetermined delay period has elapsed; during the predetermined delay period, displaying an option on the message recipient's display screen to allow the message recipient to cancel the scheduled transmission of the read receipt; and in response to a user input selecting the option to cancel the scheduled transmission of the read receipt, preventing the indication from being displayed both on the message sender's display screen and the message recipient's display screen. The advantage in scheduling the transmission of the read receipt and providing the recipient the option to cancel the scheduled transmission of the read receipt is that the recipient can reverse an accidental acknowledgement of the message.

At step 206, upon receiving the message recipient's desire to transmit the read receipt to the message sender, the mobile application transmits the read receipt to the message sender so that an indication that the text message has been received and acknowledged by the message recipient is displayed both on the message sender's display screen and the message recipient's display screen. For example, after the message recipient indicates her desire to transmit her read receipt associated with the message by performing a short tap or short touch on the message, the read receipt associated with the text message is transmitted to the message sender. The read receipt may be transmitted over cellular data, Wi-Fi, and/or any other wireless communication protocols. Upon receiving the read receipt by the message sender, the indication is displayed both on the message sender's display screen and the message recipient's display screen. In some embodiments, the indication may include, but may not be limited to, a short statement of acknowledgement associated with the message, such as a word of “read,” added next to the message. In some embodiments, the indication may include, but may not be limited to, a check mark next to the text message. In some embodiments, the indication may include, but may not be limited to, removing an unread indicator from the text message. In the above embodiments, the indication next to the message may be shown to the left, to the right, above, or below the message. In some embodiments, the message recipient may short tap on any message she has received from the message sender. In some embodiments, the indication may include a timestamp associated with a time at which the acknowledgment was received from the message recipient. In some embodiments, the indication may include a timestamp associated with a time at which the user input requesting to remove a previous acknowledgment was received from the message recipient.

At step 208, after displaying the indication on both of the display screens, the mobile application detects a second short press user input from the message recipient with respect to the text message, indicating that the message recipient desires to remove from both the display screens the read receipt that has been displayed. The second short press user input may include but may not be limited to a one-touch or two-touch action on the display screen (e.g., a touch for a predefined time period, tap, double-tap, swipe, any combination thereof, etc.). For example, after displaying the read receipt on both of the display screens, the message recipient may, based on her desires, further perform a short press on the message, as shown in FIG. 2. One technical advantage of this step is that the message recipient can reverse a previous manual, selective acknowledgement, allowing her to undo the acknowledgment if initially done inadvertently, or if she no longer wishes the acknowledgement to be displayed for the previously acknowledged message for the message sender and/or the message recipient. Another technical advantage of this step is that the messaging app is configured such that the message recipient has control over her acknowledgment receipt of the text message. In some embodiments, in order to reverse or remove a previous acknowledgement, the message recipient may short tap on any message that the read receipt has already transmitted to the message sender and displayed on the screens.

At step 210, in response to detecting the second short press user input, the associated read receipt that was displayed both on the message sender's display screen and the message recipient's display screen is removed from both display screens. In some embodiments, a communication may be sent to the message sender so that the read receipt is removed from the message sender's display screen. In some embodiments, the removal of a prior acknowledgment may be performed silently without providing a notification to the message sender and/or the message recipient. In other embodiments, the removal of a prior acknowledgment may provide a notification to the message sender. In some embodiments, the removal of a prior acknowledgement may provide the option to create a reminder to reply to the message on the recipient's smartphone.

At step 212, the mobile application detects a long press user input from the message recipient with respect to the text message, indicating that the message recipient desires to take further action with respect to the text message for which the read receipt has been displayed. For example, after displaying the read receipt on both of the display screens, the message recipient may further perform a short press or touch on the message to acknowledge receipt of another message and/or perform a long press, a swipe on the message (e.g., swipe left, right, up, or down), a double tap and/or any combination thereof to perform any other actions with respect to the message (e.g., like, delete, edit, etc.). In some embodiments, a long press user input on the message may send a read receipt and a different user input (e.g., a shorter hold, a tap, double-tap, swipe, etc.) may open a menu of options allowing the user to perform any other actions with respect to the message. In yet other embodiments, a long press user input may send a read receipt and a longer press or hold opens the menu of options. In the example of FIG. 2, a long press user input is detected at step 212 when the message recipient performs the long press on the message. A user interface element may then be displayed on the message recipient's screen at step 214. One technical advantage of this step is that the message recipient can indicate her desire to send another reaction associated with the message (e.g., like, heart, thumbs up, etc.) or perform another action with respect to the message, other than and in addition to affirmatively acknowledging the message, as performed at step 206.

At step 214, in response to detecting the long press user input, the mobile application displays a user interface element including multiple available user actions on the message recipient's display screen for selection by the message recipient. For example, the multiple available user actions may include but may not be limited to like, heart, thumbs up, edit, delete, send a message of acknowledgement, any combination thereof, etc. In some embodiments, the recipient can choose to send a message of affirmative acknowledgement from a menu of preselected options. In certain embodiments, the recipient can choose to prevent all further transmission of read receipts to the sender or prevent transmission of read receipts to the sender until a certain condition (e.g., time, location, etc.) is met.

### Additional Embodiments

In some embodiments, the computing device is configured to, in response to detecting two or more consecutive touches or taps, initiate the process of acknowledging two or more separate messages corresponding to the two or more consecutive touches or taps. In such embodiments, the two or more consecutive touches or taps may be on two or more different locations on a display device of the computing device. In some embodiments, the two or more separate messages may be those that are not received consecutively (e.g., there exists at least one message that was received by the recipient between at least two of the two or more separate messages). In such embodiments, the two or more different locations associated with the two or more separate messages touched or tapped by the recipient may include a gap, wherein the gap includes a location associated with the at least one message that was received by the recipient between at least two of the two or more separate messages.

In some embodiments, two or more consecutive touches or taps are detected on locations corresponding to two or more messages, but during a predetermined delay duration, an additional user action is received with respect to a subset of the two or more messages (e.g., 3 short taps are made for 3 different messages displayed on a singled screen, but the user has tapped the middle message again to indicate that the scheduled selective/affirmative acknowledgement for the middle message is to be canceled). In such a case, selective/affirmative acknowledgement is transmitted only for the remaining ones of the two or more messages. Such a delay duration may be indicated to the recipient using a timer displayed on the screen corresponding to each message currently in the queue for imminent selective/affirmative acknowledgement.

In some embodiments, even after selective/affirmative acknowledgement has been transmitted to the sender, the recipient can remove or retract the selective/affirmative acknowledgement by performing an action (e.g., short tap on the selectively/affirmatively acknowledged message). In some cases, a delay is applied to the removal/retraction such that the recipient can undo the action before the selective/affirmative acknowledgement is removed/retracted. In other cases, such a delay is not applied, and the selective/affirmative acknowledgement is removed/retracted without such additional delay.

Although some embodiments are described herein in the context of mobile applications and text messaging, the techniques described herein can be applied to other contexts such as desktop applications and email messages. For example, in the context of email messages, a single mouse click or a mouse swipe in a direction can be associated with the selective/affirmative acknowledgement described herein, and a double click can be associated with other actions, such as opening the email. As another example, a longer hold on an email can be associated with the selective/affirmative acknowledgement described herein, and a shorter hold or tap can be associated with other actions, such as opening the email. In some embodiments, selective/affirmative acknowledgement is allowed in the list view of emails. In other embodiments, selective/affirmative acknowledgement is disabled in the list view of emails but allowed after an email has been opened (e.g., as a separate window or in the preview window), where a short touch or tap or a click on the body of the received email (or another portion of the window associated with the selected/opened email) initiates selective/affirmative acknowledgement of the email.

Although some embodiments are described herein with reference to certain user actions (e.g., short tap, long tap, hold, swipe, etc.), other actions such as mouse clicks, voice commands, visual commands, etc. can be used instead of or in combination with such user actions to perform the tasks described herein.

In some embodiments, the selective/affirmative acknowledgement is displayed as a separate icon, indication, wording, etc. near or on top of the acknowledged message. in other embodiments, the selective/affirmative acknowledgement is transmitted as a new message including the indication or as a reply to the message including the indication.

### Computer System

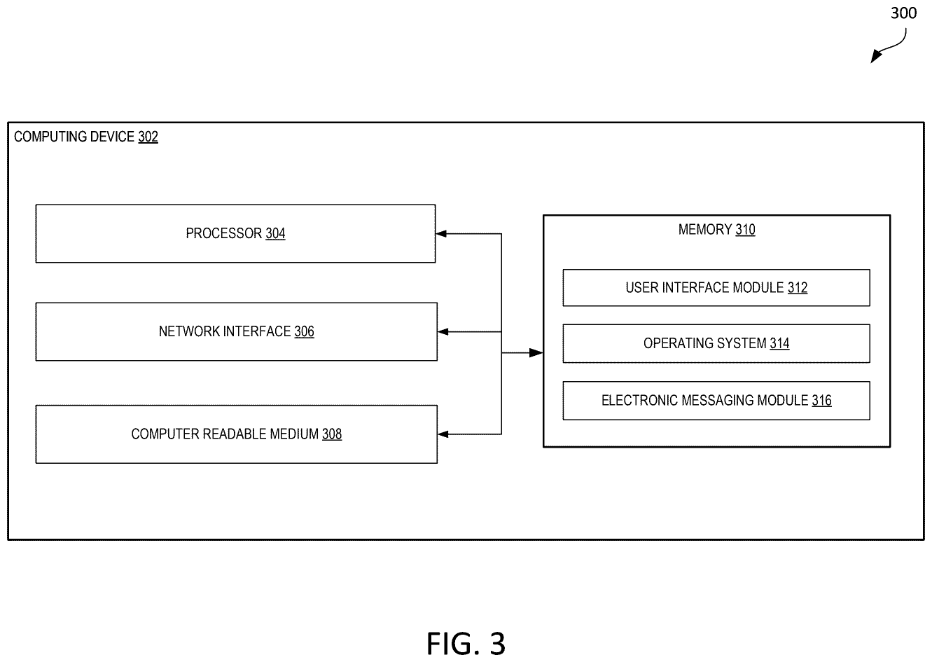

In some embodiments, the systems, processes, and methods described herein are implemented using a computing system, such as the one illustrated in FIG. 3. The example computer system 300 is in communication with one or more computing devices 302 and/or one or more data sources via one or more networks. The computing device 302 can be any computing device such as a desktop, a laptop, a mobile phone (or smartphone), a tablet, a kiosk, a television, a wristwatch (including a smartwatch), a wireless device, a media player, one or more processor devices, integrated circuit components for inclusion in computing devices, and the like. Additionally, the one or more networks may be any wired network, wireless network, or combination thereof. In addition, the one or more networks may be a personal area network, local area network, wide area network, over-the-air broadcast network, cable network, satellite network, cellular telephone network, or combinations thereof. In some embodiments, the one or more networks may be a private or semi-private network, and may include one or more wireless networks, such as a Global System for Mobile Communications (GSM) network, a Code Division Multiple Access (CDMA) network, a Long Term Evolution (LTE) network, or any other type of wireless network. The one or more networks can use protocols and components for communicating via the Internet or any of the other aforementioned types of networks.

While FIG. 3 illustrates an embodiment of a computing system 300, it is recognized that the functionality provided for in the components and modules of computer system 300 can be combined into fewer components and modules, or further separated into additional components and modules.

The computer system 300 can comprise an electronic messaging module 316 that carries out the functions, methods, acts, and/or processes described herein. The electronic messaging module 316 is executed on the computer system 300 by a processor 304 discussed further below.

In general the word “module,” as used herein, refers to logic embodied in hardware or firmware or to a collection of software instructions, having entry and exit points. Modules are written in a program language, such as JAVA, C, or C++, or the like. Software modules can be compiled or linked into an executable program, installed in a dynamic link library, or can be written in an interpreted language such as BASIC, PERL, LAU, PHP or Python and any such languages. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems, and can be stored on or within any suitable computer readable medium, or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted.

As illustrated, the computing device 302 includes a processor 304, a network interface 306, and a computer readable medium 308, all of which may communicate with one another by way of a communication bus. The network interface 306 may provide connectivity to one or more networks or computing systems. The processor 304 may thus receive information and instructions from other computing systems or services.

The processor 304 may also communicate with memory 310. The memory 310 may contain computer program instructions (grouped as modules in some embodiments) that the processor 304 executes in order to implement one or more aspects of the present disclosure. The memory 310 may include RAM, ROM, and/or other persistent, auxiliary, or non-transitory computer-readable media. The memory 310 may store an operating system 314 that provides computer program instructions for use by the processor 304 in the general administration and operation of the computing device 302. The memory 310 may further include computer program instructions and other information for implementing one or more aspects of the present disclosure. For example, in one embodiment, the memory 310 includes a user interface module 312 that generates user interfaces (and/or instructions therefor) for display upon a user computing device, e.g., via a navigation and/or browsing interface such as a browser or application installed on the user computing device. In addition, the memory 310 may include or communicate with one or more data stores.

In addition to and/or in combination with the user interface module 312, the memory 310 may include an electronic messaging module 316 that may be executed by the processor 304. In one embodiment, the electronic messaging module 316 implements various aspects of the present disclosure, e.g., those illustrated in FIGS. 1-2 or described with reference to FIGS. 1-2.

While the electronic messaging module 316 is shown in FIG. 3 as part of the computing system 300, in other embodiments, all or a portion of the electronic messaging module 316 may be implemented by other components and/or another computing device. For example, in certain embodiments of the present disclosure, another computing device may include several modules or components that operate similarly.

Although a single processor, a single network interface, a single computer readable medium, and a single memory are illustrated in the example of FIG. 3, in other implementations, the computing system 300 can have a multiple of one or more of these components (e.g., two or more processors and/or two or more memories).

Memory 310 may include random access memory (RAM) for temporary storage of information, a read only memory (ROM) for permanent storage of information, and a mass storage device, such as a backing store, hard drive, rotating magnetic disks, solid state disks (SSD), flash memory, phase-change memory (PCM), 3D XPoint memory, diskette, or optical media storage device. Alternatively, the mass storage device can be implemented in an array of servers. Typically, the components of the computer system 300 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 300 may include one or more input/output (I/O) devices and interfaces, such as a keyboard, mouse, touch pad, and printer. The I/O devices and interfaces can include one or more display devices, such as a monitor, that allows the visual presentation of data to a user. More particularly, a display device provides for the presentation of GUIs as application software data, and multi-media presentations, for example. The I/O devices and interfaces can also provide a communications interface to various external devices. The computer system can comprise one or more multi-media devices, such as speakers, video cards, graphics accelerators, and microphones, for example.

The computing system 300 illustrated in FIG. 3 may be coupled to a network, such as a LAN, WAN, or the Internet via a communication link (wired, wireless, or a combination thereof). The network communicates with various computing devices and/or other electronic devices. The network is communicating with one or more computing systems 300 and one or more data sources. The electronic messaging module 316 can access or can be accessed by computing systems 300 and/or data sources through a web-enabled user access point. Connections can be a direct physical connection, a virtual connection, and other connection type. The web-enabled user access point can comprise a browser module that uses text, graphics, audio, video, and other media to present data and to allow interaction with data via the network.

### URLs and Cookies

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Doman Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

### Other Embodiments

While operations may be depicted in the drawings or described in the specification in a particular order, such operations need not be performed in the particular order shown or in sequential order, or that all operations be performed, to achieve desirable results. In particular, elements presented relating to GUI elements or displays to a user may be presented in any particular order to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some examples, the actual steps taken in the processes illustrated and/or disclosed may differ from those shown in the figures. Depending on the example, certain of the steps described above may be removed or others may be added. Furthermore, the features and attributes of the specific examples disclosed above may be combined in different ways to form additional examples, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the features described herein can be provided separately, or integrated together (e.g., packaged together, or attached together).

For purposes of this disclosure, certain aspects, advantages, and novel features are described herein. Not necessarily all such advantages may be achieved in accordance with any particular example. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include logic for deciding, with or without user input or prompting, whether these features, elements, and/or steps are included or are to be performed in any particular example.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

Language of degree used herein, such as the terms “approximately,” “about,” “generally,” and “substantially” represent a value, amount, or characteristic close to the stated value, amount, or characteristic that still performs a desired function or achieves a desired result.

The scope of the present disclosure is not intended to be limited by the specific disclosures of preferred examples in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Although the foregoing invention has been described in terms of certain preferred embodiments, other embodiments will be apparent to those of ordinary skill in the art. Additionally, other combinations, omissions, substitutions and modification will be apparent to the skilled artisan, in view of the disclosure herein. Accordingly, the present invention is not intended to be limited by the recitation of the preferred embodiments, but is instead to be defined by reference to the appended claims. All references cited herein are incorporated by reference in their entirety.

The terminology used in the description presented herein is not intended to be interpreted in any limited or restrictive manner and unless otherwise indicated refers to the ordinary meaning as would be understood by one of ordinary skill in the art in view of the specification. Furthermore, embodiments may comprise, consist of, consist essentially of, several novel features, no single one of which is solely responsible for its desirable attributes or is believed to be essential to practicing the embodiments herein described. As used herein, the section headings are for organizational purposes only and are not to be construed as limiting the described subject matter in any way. All literature and similar materials cited in this application, including but not limited to, patents, patent applications, articles, books, treatises, and internet web pages are expressly incorporated by reference in their entirety for any purpose. When definitions of terms in incorporated references appear to differ from the definitions provided in the present teachings, the definition provided in the present teachings shall control. It will be appreciated that there is an implied “about” prior to the temperatures, concentrations, times, etc. discussed in the present teachings, such that slight and insubstantial deviations are within the scope of the present teachings herein.

Although this disclosure is in the context of certain embodiments and examples, those of ordinary skill in the art will understand that the present disclosure extends beyond the specifically disclosed embodiments to other alternative embodiments and/or uses of the embodiments and obvious modifications and equivalents thereof. In addition, while several variations of the embodiments have been shown and described in detail, other modifications, which are within the scope of this disclosure, will be readily apparent to those of ordinary skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes or embodiments of the disclosure. Thus, it is intended that the scope of the present disclosure herein disclosed should not be limited by the particular disclosed embodiments described above.

### EXAMPLE EMBODIMENTS (EE)

EE 1: A method for acknowledging message transmission, comprising: receiving a text message from a message sender in a chat room between the message sender and a message recipient on a mobile application executing on a smartphone associated with the message recipient; detecting a short press user input from the message recipient with respect to the text message, indicating that a read receipt associated with the text message is to be transmitted to the message sender; transmitting the read receipt to the message sender such that an indication that the text message has been received and acknowledged by the message recipient is displayed both on the message sender's display screen and the message recipient's display screen; subsequent to displaying the indication on both of the display screens, detecting a long press user input from the message recipient with respect to the text message, indicating that the message recipient desires to take further action with respect to the text message for which the read receipt has been displayed; and in response to detecting the long press user input, causing a user interface element including multiple available user actions to be displayed on the message recipient's display screen for selection by the message recipient.

EE 2: A method for acknowledging message transmission, comprising: receiving a text message from a message sender in a chat room between the message sender and a message recipient on a mobile application executing on a smartphone associated with the message recipient; detecting a first short press user input from the message recipient with respect to the text message, indicating that a read receipt associated with the text message is to be transmitted to the message sender; transmitting the read receipt to the message sender such that an indication that the text message has been received and acknowledged by the message recipient is displayed both on the message sender's display screen and the message recipient's display screen; subsequent to displaying the indication on both of the display screens, detecting a second short press user input from the message recipient with respect to the text message, indicating that the message recipient desires to take further action with respect to the text message for which the read receipt has been displayed; in response to detecting the second short press user input, causing the indication that the message has been received and acknowledged by the message recipient to be removed from both the message sender's display screen and the message recipient's display screen; detecting a long press user input from the message recipient with respect to the text message, indicating that the message recipient desires to take further action with respect to the text message for which the read receipt has been displayed, wherein a duration associated with the long press user input is longer than a duration associated with the first short press user input and the second short press user input; and in response to detecting the long press user input, causing a user interface element including multiple available user actions to be displayed on the message recipient's display screen for selection by the message recipient.

EE 3: The method of EE 2, further comprising: scheduling transmission of the read receipt after a predetermined delay period has elapsed; during the predetermined delay period, displaying an option on the message recipient's display screen to allow the message recipient to cancel the scheduled transmission of the read receipt; and in response to a user input selecting the option to cancel the scheduled transmission of the read receipt, preventing the indication from being displayed both on the message sender's display screen and the message recipient's display screen.

EE 4: The method of EE 2, further comprising: displaying an option on the message recipient's display screen to create a reminder to reply to the text message on the smartphone associated with the message recipient.

EE 5: The method of EE 2, wherein detecting the second short press user input from the message recipient with respect to the text message further comprises: displaying an option on the message recipient's display screen to send a notification to the message sender that the read receipt has been removed.

EE 6: The method of EE 2, further comprising: displaying an option on the message recipient's display screen to send a message of affirmative acknowledgement from a menu of predetermined reply options.

EE 7: The method of EE 2, further comprising: displaying an option on the message recipient's display screen to turn off read receipts with the message sender until a certain condition is met.

EE 8: The method of EE 2, further comprising: detecting two or more consecutive short press user inputs each with a different one of a plurality of messages received from the message sender and displayed on a single display screen within the mobile application; and initiating transmission of selective and affirmative acknowledgement for each of the plurality of messages.

EE 9: An apparatus for acknowledging message transmission, comprising: a processor; and a memory storing instructions that, when executed by the processor, configures the processor to: receive a text message from a message sender in a chat room between the message sender and a message recipient on a mobile application executing on a smartphone associated with the message recipient; detect a first short press user input from the message recipient with respect to the text message, indicating that a read receipt associated with the text message is to be transmitted to the message sender; transmit the read receipt to the message sender such that an indication that the text message has been received and acknowledged by the message recipient is displayed both on the message sender's display screen and the message recipient's display screen; subsequent to displaying the indication on both of the display screens, detect a second short press user input from the message recipient with respect to the text message, indicating that the message recipient desires to take further action with respect to the text message for which the read receipt has been displayed; in response to detecting the second short press user input, cause the indication that the message has been received and acknowledged by the message recipient to be removed from both the message sender's display screen and the message recipient's display screen; detect a long press user input from the message recipient with respect to the text message, indicating that the message recipient desires to take further action with respect to the text message for which the read receipt has been displayed; and in response to detecting the long press user input, cause a user interface element including multiple available user actions to be displayed on the message recipient's display screen for selection by the message recipient.

EE 10: The apparatus of EE 9, wherein the recipient device is further configured to: schedule transmission of the read receipt after a predetermined delay period has elapsed; during the predetermined delay period, display an option on the message recipient's display screen to allow the message recipient to cancel the scheduled transmission of the read receipt; and in response to a user input selecting the option to cancel the scheduled transmission of the read receipt, prevent the indication from being displayed both on the message sender's display screen and the message recipient's display screen.

EE 11: The apparatus of EE 9, wherein the recipient device is further configured to: display an option on the message recipient's display screen to create a reminder to reply to the text message on the recipient device.

EE 12: The apparatus of EE 9, wherein the recipient device is further configured to: display an option on the message recipient's display screen to send a notification to the message sender that the read receipt has been removed.

EE 13: The apparatus of EE 9, wherein the recipient device is further configured to: display an option on the message recipient's display screen to send a message of affirmative acknowledgement from a menu of predetermined reply options.

EE 14: The apparatus of EE 9, wherein the recipient device is further configured to: display an option on the message recipient's display screen to turn off read receipts with the message sender.

EE 15: The apparatus of EE 9, wherein the recipient device is further configured to: display an option on the message recipient's display screen to turn off read receipts with the message sender until a certain condition is met.

EE 16: A non-transitory computer-readable medium storing instructions that, when executed by a processor, cause a computer system to perform a method for acknowledging message transmission comprising: receiving a text message from a message sender in a chat room between the message sender and a message recipient on a mobile application executing on a smartphone associated with the message recipient; detecting a short press user input from the message recipient with respect to the text message, indicating that a read receipt associated with the text message is to be transmitted to the message sender; transmitting the read receipt to the message sender such that an indication that the text message has been received and acknowledged by the message recipient is displayed both on the message sender's display screen and the message recipient's display screen; subsequent to displaying the indication on both of the display screens, detecting a second short press user input from the message recipient with respect to the text message, indicating that the message recipient desires to take further action with respect to the text message for which the read receipt has been displayed; in response to detecting the second short press user input, causing the indication that the message has been received and acknowledged by the message recipient to be removed from both the message sender's display screen and the message recipient's display screen; detecting a long press user input from the message recipient with respect to the text message, indicating that the message recipient desires to take further action with respect to the text message for which the read receipt has been displayed; and in response to detecting the long press user input, causing a user interface element including multiple available user actions to be displayed on the message recipient's display screen for selection by the message recipient.

EE 17: The computer-readable medium of EE 16, wherein the method further comprises: scheduling transmission of the read receipt after a predetermined delay period has elapsed; during the predetermined delay period, displaying an option on the message recipient's display screen to allow the message recipient to cancel the scheduled transmission of the read receipt; and in response to a user input selecting the option to cancel the scheduled transmission of the read receipt, preventing the indication from being displayed both on the message sender's display screen and the message recipient's display screen.

EE 18: The computer-readable medium of EE 16, wherein detecting the second short press user input from the message recipient with respect to the text message further comprises: displaying an option on the message recipient's display screen to create a reminder to reply to the text message on the smartphone associated with the message recipient.

EE 19: The computer-readable medium of EE 16, wherein detecting the second short press user input from the message recipient with respect to the text message further comprises: displaying an option on the message recipient's display screen to send a notification to the message sender that the read receipt has been removed.

EE 20: The computer-readable medium of EE 16, further comprising: displaying an option on the message recipient's display screen to send a message of affirmative acknowledgement from a menu of predetermined reply options.

EE 21: The computer-readable medium of EE 16, further comprising: displaying an option on the message recipient's display screen to turn off read receipts with the message sender.

What is claimed is:

1. A method for acknowledging message transmission, comprising:
receiving a text message from a message sender in a chat room between the message sender and a message recipient on a mobile application executing on a smartphone associated with the message recipient;
detecting a first short press user input from the message recipient with respect to the text message, indicating that a read receipt associated with the text message is to be transmitted to the message sender;
transmitting the read receipt to the message sender such that an indication that the text message has been received and acknowledged by the message recipient is displayed both on the message sender's display screen and the message recipient's display screen;
subsequent to displaying the indication on both of the display screens, detecting a second short press user input from the message recipient with respect to the text message, indicating that the message recipient desires to take further action with respect to the text message for which the read receipt has been displayed;
in response to detecting the second short press user input, causing the indication that the message has been received and acknowledged by the message recipient to be removed from both the message sender's display screen and the message recipient's display screen;
detecting a long press user input from the message recipient with respect to the text message, indicating that the message recipient desires to take further action with respect to the text message for which the read receipt has been displayed, wherein a duration associated with the long press user input is longer than a duration associated with the first short press user input and the second short press user input; and
in response to detecting the long press user input, causing a user interface element including multiple available user actions to be displayed on the message recipient's display screen for selection by the message recipient.

2. The method of claim 1, further comprising:
scheduling transmission of the read receipt after a predetermined delay period has elapsed;
during the predetermined delay period, displaying an option on the message recipient's display screen to allow the message recipient to cancel the scheduled transmission of the read receipt; and
in response to a user input selecting the option to cancel the scheduled transmission of the read receipt, preventing the indication from being displayed both on the message sender's display screen and the message recipient's display screen.

3. The method of claim 1, further comprising:
displaying an option on the message recipient's display screen to create a reminder to reply to the text message on the smartphone associated with the message recipient.

4. The method of claim 1, wherein detecting the second short press user input from the message recipient with respect to the text message further comprises:
displaying an option on the message recipient's display screen to send a notification to the message sender that the read receipt has been removed.

5. The method of claim 1, further comprising:
displaying an option on the message recipient's display screen to send a message of affirmative acknowledgement from a menu of predetermined reply options.

6. The method of claim 1, further comprising:
displaying an option on the message recipient's display screen to turn off read receipts with the message sender until a certain condition is met.

7. The method of claim 1, further comprising:
detecting two or more consecutive short press user inputs each with a different one of a plurality of messages received from the message sender and displayed on a single display screen within the mobile application; and
initiating transmission of selective and affirmative acknowledgement for each of the plurality of messages.

8. An apparatus for acknowledging message transmission, comprising:
a processor; and
a memory storing instructions that, when executed by the processor, configures the processor to:
receive a text message from a message sender in a chat room between the message sender and a message recipient on a mobile application executing on a smartphone associated with the message recipient;
detect a first short press user input from the message recipient with respect to the text message, indicating that a read receipt associated with the text message is to be transmitted to the message sender;
transmit the read receipt to the message sender such that an indication that the text message has been received and acknowledged by the message recipient is displayed both on the message sender's display screen and the message recipient's display screen;
subsequent to displaying the indication on both of the display screens, detect a second short press user input from the message recipient with respect to the text message, indicating that the message recipient desires to take further action with respect to the text message for which the read receipt has been displayed;
in response to detecting the second short press user input, cause the indication that the message has been received and acknowledged by the message recipient to be removed from both the message sender's display screen and the message recipient's display screen;
detect a long press user input from the message recipient with respect to the text message, indicating that the message recipient desires to take further action with respect to the text message for which the read receipt has been displayed; and
in response to detecting the long press user input, cause a user interface element including multiple available user actions to be displayed on the message recipient's display screen for selection by the message recipient.

9. The apparatus of claim 8, wherein the recipient device is further configured to:
schedule transmission of the read receipt after a predetermined delay period has elapsed;
during the predetermined delay period, display an option on the message recipient's display screen to allow the message recipient to cancel the scheduled transmission of the read receipt; and
in response to a user input selecting the option to cancel the scheduled transmission of the read receipt, prevent the indication from being displayed both on the message sender's display screen and the message recipient's display screen.

10. The apparatus of claim 8, wherein the recipient device is further configured to:
display an option on the message recipient's display screen to create a reminder to reply to the text message on the recipient device.

11. The apparatus of claim 8, wherein the recipient device is further configured to:
display an option on the message recipient's display screen to send a notification to the message sender that the read receipt has been removed.

12. The apparatus of claim 8, wherein the recipient device is further configured to:
display an option on the message recipient's display screen to send a message of affirmative acknowledgement from a menu of predetermined reply options.

13. The apparatus of claim 8, wherein the recipient device is further configured to:
display an option on the message recipient's display screen to turn off read receipts with the message sender.

14. The apparatus of claim 8, wherein the recipient device is further configured to:
display an option on the message recipient's display screen to turn off read receipts with the message sender until a certain condition is met.

15. A non-transitory computer-readable medium storing instructions that, when executed by a processor, cause a computer system to perform a method for acknowledging message transmission comprising:
receiving a text message from a message sender in a chat room between the message sender and a message recipient on a mobile application executing on a smartphone associated with the message recipient;
detecting a short press user input from the message recipient with respect to the text message, indicating that a read receipt associated with the text message is to be transmitted to the message sender;
transmitting the read receipt to the message sender such that an indication that the text message has been received and acknowledged by the message recipient is displayed both on the message sender's display screen and the message recipient's display screen;
subsequent to displaying the indication on both of the display screens, detecting a second short press user input from the message recipient with respect to the text message, indicating that the message recipient desires to take further action with respect to the text message for which the read receipt has been displayed;
in response to detecting the second short press user input, causing the indication that the message has been received and acknowledged by the message recipient to be removed from both the message sender's display screen and the message recipient's display screen;
detecting a long press user input from the message recipient with respect to the text message, indicating that the message recipient desires to take further action with respect to the text message for which the read receipt has been displayed; and
in response to detecting the long press user input, causing a user interface element including multiple available user actions to be displayed on the message recipient's display screen for selection by the message recipient.

16. The computer-readable medium of claim 15, wherein the method further comprises:
scheduling transmission of the read receipt after a predetermined delay period has elapsed;
during the predetermined delay period, displaying an option on the message recipient's display screen to allow the message recipient to cancel the scheduled transmission of the read receipt; and
in response to a user input selecting the option to cancel the scheduled transmission of the read receipt, preventing the indication from being displayed both on the message sender's display screen and the message recipient's display screen.

17. The computer-readable medium of claim 15, wherein detecting the second short press user input from the message recipient with respect to the text message further comprises:
displaying an option on the message recipient's display screen to create a reminder to reply to the text message on the smartphone associated with the message recipient.

18. The computer-readable medium of claim 15, wherein detecting the second short press user input from the message recipient with respect to the text message further comprises:
displaying an option on the message recipient's display screen to send a notification to the message sender that the read receipt has been removed.

19. The computer-readable medium of claim 15, further comprising:
displaying an option on the message recipient's display screen to send a message of affirmative acknowledgement from a menu of predetermined reply options.

20. The computer-readable medium of claim 15, further comprising:
displaying an option on the message recipient's display screen to turn off read receipts with the message sender.
